(19) United States
(12) Patent Application Publication
(10) Pub. No.: US 2007/0022663 A1
(43) Pub. Date: Feb. 1, 2007

(54) Sealing configuration for a sliding door

(75) Inventors: Jeno Faflek, Arnsberg (DE); Carl-Julius Cronenberg, Arnsberg (DE)

Correspondence Address: LERNER GREENBERG STEMER LLP, P O BOX 2480, HOLLYWOOD, FL, 33022-2480, US

(73) Assignee: F. Athmer

(21) Appl. No.: 11/496,245

(22) Filed: Jul. 31, 2006

(30) Foreign Application Priority Data
Jul. 30, 2005 (DE) 20 2005 011 984.9

(51) Int. Cl. E06B 7/20

(52) U.S. Cl. 49/306

(57) ABSTRACT

A sealing configuration for a sliding door contains a floor seal which can be lowered via a mechanism. The mechanism has a release device which protrudes on the end side of the door leaf and, during the closure of the sliding door, is pressed in counter to a spring force of a lowering mechanism, which spring force acts upon the release device. A closing mechanism is provided for the sliding door in order to oppose the an opening tendency of the sliding door which is due to the spring-loaded release device. The closing mechanism containing at least one magnet element which draws the door leaf in the closing direction.

### BACKGROUND OF THE INVENTION

1 Field of the Invention:

The present invention relates to a sealing configuration for a sliding door, containing a floor seal which can be lowered via a mechanism. The mechanism contains a release device which protrudes on the end side of the door leaf and, during the closure of the sliding door, is pressed in counter to a spring force of the lowering mechanism. The spring force acts upon the release device, with a closing mechanism being provided for the sliding door in order to oppose the sliding door's opening tendency which is provided by the spring-loaded release device.

Published, non-prosecuted German patent DE 35 26 720 A1, corresponding to European patent 0 209 678 B1 (in English), describes a sealing configuration for a sliding door of the generic type mentioned at the beginning, in which the closing mechanism contains a coupling element which is approximately in the shape of a peg, with an abutment, a neck-shaped tapered portion and a head. This coupling element is received by a hole in the end region of the sliding door, with it being possible to produce a tension-proof connection between the coupling element and the sliding door via two radially displaceable balls. This is therefore a mechanical connection similar to a latching connection, which is released again by a corresponding tensile force during the opening of the sliding door.

In the case of a sliding door with a lowerable floor seal, a closing mechanism is required, since the release device is spring-loaded and, as a result, when the sliding door is pushed shut, the release device attempts to relax, i.e. to push away from the frame component against which the sliding door is pushed, thus producing the sliding door's opening tendency. The wider the sliding door is, the greater the force required in order to lower the floor seal over the length of the sliding door into its closing position has to be. Accordingly, the sliding door's opening tendency increases with increasing width of the sliding door because of the spring-loaded release device. In order to avoid an automatic opening of the sliding door, use has therefore generally been made in the case of conventional sliding doors of a locking mechanism which secures the sliding door in the closed position, but which has the disadvantage that then, in order to open the sliding door, a manual unlocking first has to be carried out. This results in that a simple sideways sliding movement is insufficient for opening the sliding door. Such an unlocking requirement reduces the ease of operation when actuating the sliding door.

In the case of the sealing configuration for a sliding door known from published, non-prosecuted German patent application DE 35 26 720, which is mentioned at the beginning, it is disadvantageous that a very precise guidance of the sliding door is required so that the peg enters exactly into the corresponding receptacle of the sliding door. In practice, such an exact guidance for a sliding door can only be realized with a great outlay and so the solution known from the prior art cannot be used in an economically expedient manner.

### SUMMARY OF INVENTION

It is accordingly an object of the invention to provide a sealing configuration for a sliding door that overcomes the above-mentioned disadvantages of the prior art devices of this general type, in which the closing mechanism, which opposes the opening tendency by the spring-loaded release device, is configured in such a manner that the sliding door can nevertheless be opened in a convenient and simple manner.

With the foregoing and other objects in view there is provided, in accordance with the invention, a sealing configuration for a sliding door having a door leaf. The sealing configuration contains a floor seal and a mechanism for lowering the floor seal. The mechanism has a defined spring force and a release device protruding from an end side of the door leaf and, during a closure of the sliding door, the release device is pressed in counter to the defined spring force acting upon the release device. A closing mechanism is provided for opposing an opening tendency of the sliding door occurring due to the defined spring force acting on the release device. The closing mechanism contains at least one magnet element for drawing the door leaf in a closing direction.

According to the invention, provision is made for the closing mechanism to contain at least one magnet element which draws the door leaf in the closing direction. According to the invention, the magnetic force can be adapted to the release force for the floor seal of the sliding door. In the case of a sliding-door seal which is optimized in terms of the release force, the release force is, for example, of the order of magnitude of up to 20 N/m. In the case of floor seals which are conventionally released automatically, the release forces are usually in the region of 20 to 60 N depending on the width of the sliding door. Owing to the fact that, in the solution according to the invention, the sliding door is drawn in the closing direction by the magnet element, a lock or a similar closing mechanism can be omitted. However, the magnetic force is also not to be selected to be too severe, since otherwise an excessive force again has to be applied in order to open the sliding door. Ideally, the magnetic force is therefore selected in such a manner that the sliding door's tendency to open, which is provided by the release device acted upon with a spring force, is overcompensated for only to a certain extent. Parameters which influence the magnetic force are, in particular, the size of the magnet element and/or the material of which the magnet element is composed. However, the magnetic force acting in the closing direction of the sliding door can also be varied via the size and/or material thickness of the counterpart. In this manner, a fine tuning can also be undertaken via the counterpart. The magnetic forces are determined by the magnet through the magnetic flux, on the one hand, and by the counterpart, on the other hand. If more magnetic force lines can flow through the two parts, the magnetic force increases. The ideal ratio is present, for example, when magnetic element and counterpart have approximately the same material thickness. If the counterpart is selected to be thinner, the magnetic force is reduced. The required retaining force of the magnet can therefore be adapted, for example, by simple exchange of, for example, approximately plate-shaped metallic counterparts of differing thickness. According to a preferred development of the invention, the plate used as the counterpart can also be used at the same time as an abutment for the release device of the lowerable floor seal. The floor seal may be fastened to the door leaf, for example, via an angle bracket, and it is possible, for example, to fix the magnet element on this angle bracket. The counterpart is preferably fixed on the frame against which the sliding door closes. In principle, however, it is also possible to interchange the position of magnet element and counterpart, so that the magnet element is situated on the frame. A possible, preferred configuration variant makes provision, for example, for the magnet element to be at least partially embedded in a groove of the door leaf or the frame. In this case, the magnet element may also be mounted in an axially resilient manner, for example, via a spring element in such a groove of the door leaf or the frame. As a result, it is possible to allow the magnet element to protrude to a certain extent in relation to the door leaf or the frame and, during the closing of the sliding door, the magnet element then springs back to a certain extent into the groove.

The magnet element can be fixed on the door leaf above the fastening device for the floor seal or can be integrated into the fastening device. The magnet element can be fixed on the door leaf, for example, via a screw or via an adhesive connection. According to a preferred development of the invention, the magnet element can be approximately disc-shaped or approximately annular configuration, with the magnet element being perforated, for example, approximately centrally and then being able to be fixed on the end side of the door leaf directly via a fastening screw or a similar fastening element or together with the angle bracket.

A preferred development of the solution, according to the invention, of the object makes provision for the magnet element to be integrated in an angle bracket which serves to fix the lowerable floor seal on the door leaf. The angle bracket may also have, for example, a slot, so that it is possible to fasten the angle bracket on the door leaf in an angular position with respect thereto and, as a result, to produce a sloping plane or else to compensate as a result for a door which is installed in a somewhat sloping manner. By such a slot in an angle bracket, the floor seal for the sliding door may also consciously be installed in a somewhat sloping manner.

Since the “frame clearance”, i.e. the distance between the door leaf and the frame, can vary, or else the door leaf is not always installed in such a manner that it runs parallel to the plane of the frame, it is advantageous if the magnet element is mounted in an axially resilient manner.

The magnetic force can be roughly set, for example, by the manufacturer, depending on the length of the respective floor seal, by the respective size of the magnet element and the material of which the latter is composed being appropriately selected. The fine tuning can then take place, if appropriate, in situ by the fitter, for example, in the manner already mentioned, by the respective selection of the size and the material thickness of the counterpart.

Other features which are considered as characteristic for the invention are set forth in the appended claims.

Although the invention is illustrated and described herein as embodied in a sealing configuration for a sliding door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partial perspective view of a lower region of a door leaf of a sliding door with a sealing configuration according to the invention;

FIG. 2 is a diagrammatic, vertical sectional view of the lower region of the door leaf according to a first embodiment shown in FIG. 1;

FIG. 3 is a diagrammatic, perspective view of a second embodiment of the sealing configuration according to the invention;

FIG. 4 is a diagrammatic, vertical sectional view of the sealing configuration according to FIG. 3, but with the floor seal here being shown in a different state than in the case of the lowered state in FIG. 2;

FIG. 5 is a diagrammatic, partial perspective view of a door leaf with the sealing configuration according to a third embodiment of the invention; and

FIG. 6 is a diagrammatic, exploded perspective view of the sealing configuration according to the third embodiment shown in FIG. 5.

### DESCRIPTION OF THE PREFERRED EMBODIMENTS

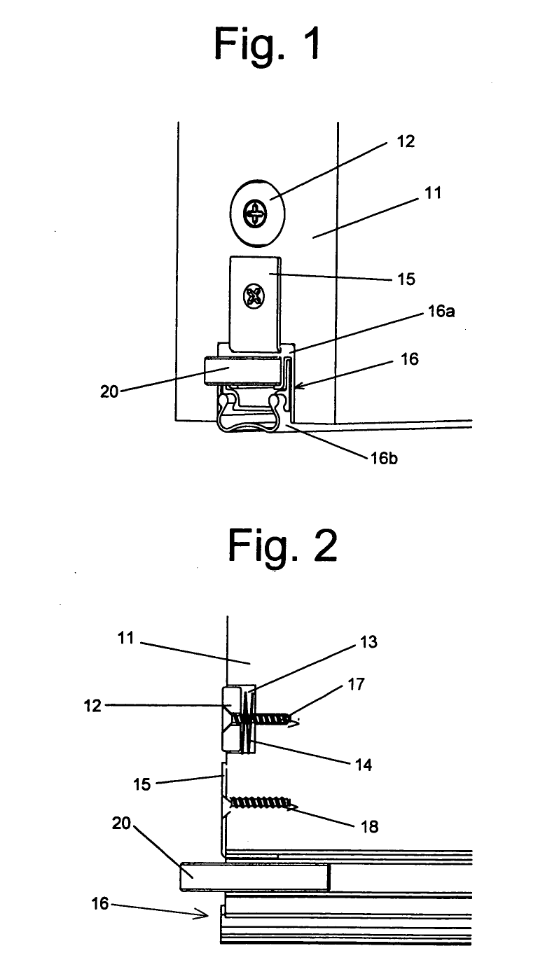

Referring now to the figures of the drawing in detail and first, particularly, to FIG. 1 thereof, there is shown a simplified perspective view of a lower region of a door leaf 11, looking approximately at an end side of the door leaf. It can be seen that there is a lowerable floor seal which is designated in its entirety by 16 and which is embedded in a groove 16a of the door leaf 11. The lowerable floor seal 16 includes a sealing profile 16b which, in the lowered position of the seal, comes to bear on the underlying surface and therefore seals off the lower door gap. A lowering movement is triggered via a release device 20 which protrudes on the end side of the door leaf 11. The release device 20 is pressed in during the closing of the door and then causes a spring-actuated lowering mechanism (not described here in more detail) to lower the sealing profile 16b in a manner known per se. Since the release device 20 is acted upon by a spring force of the lowering mechanism and a sliding door is involved, this results in the springs attempting to force the release device 20 back into a starting position (also see FIG. 2 in this respect), in which the release device 20 protrudes a little on the end side of the door leaf 11 and in which the springs of the lowering mechanism are relaxed. This leads to an opening tendency of the sliding door, for which reason, in the case of conventional sliding doors with a floor seal, there is generally a lock which prevents the sliding door from opening automatically.

The solution according to the invention makes provision for there to be a magnet element 12 which, in the exemplary embodiment according to FIGS. 1 and 2, is situated in a groove 13 of the door leaf. A corresponding counterpart (see reference number 21 in FIG. 4) is situated on the door frame, with the result that the door leaf 11 is drawn into a closing position by a magnetic force, which overcompensates for the spring force which acts on the release device 20 and remains in the closing position.

As can be seen from FIG. 1, the magnet element 12 is a magnet component which is, for example, circular in outline and is of an approximately disc-shaped configuration (also see FIG. 2). The magnet element 12 is situated above an angle bracket 15 by which the lowerable floor seal 16 is fastened to the door leaf 11.

FIG. 2 shows that the magnet element 12 is partially accommodated by the groove 13, but, when the door is open, one part can protrude on the end side in relation to the door leaf 11. The magnet element 12 is fastened to the door leaf, for example, by a screw 17. The screw 17 can extend through the disc-shaped magnet element 12. In the exemplary embodiment according to FIG. 2, a spring 14, for example, a spiral spring, is also provided, the spring 14 surrounding the screw 17 and being disposed in the groove 13 between the magnet element 12 and groove base. As a result, the magnet element 12 is mounted in a flexibly resilient manner counter to the force of the spring 14. It therefore does not matter if the magnet element 12 protrudes slightly further than shown in the drawing of FIG. 2. Tolerances in the spacing between the end side of the door leaf 11 and the door frame, against which the sliding door closes, can therefore also be compensated for. Owing to the magnetic force, the magnet element 12 is drawn out of the groove 13, if appropriate, also counter to the spring force 14, when it passes into the vicinity of the counterpart 21, so that tolerances can also be spanned here. In this variant of the invention, the angle bracket 15 is screwed to the door leaf 11, for example, via a further screw 18, in order to fasten the floor seal 16.

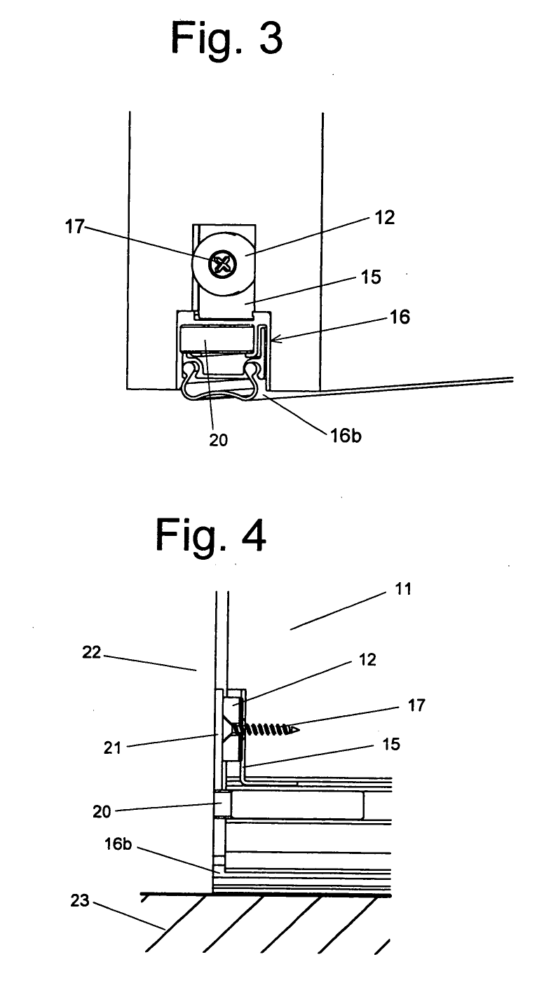

The second embodiment according to FIGS. 3 and 4, shows a construction solution somewhat deviating from this. In this variant, the magnet element 12 is combined with the angle bracket 15 to form a structural element. As a result, the magnet element 12 and the floor seal 16 can be fastened at the same time with just one fastening screw 17 which is screwed through the magnet element 12 and also the angle bracket 15 (see FIG. 4). The disc-shaped magnet element 12 with the central hole for the fastening screw 17 can be adhesively bonded, for example, on to the angle bracket 15.

FIG. 4 also shows the counterpart 21 in the form of a metal plate which is situated on a frame 22 for the sliding door.

It can also readily be seen in FIG. 4 that, in the closing position between the frame 22 and door leaf 11, a gap remains which is spanned by the counterpart 21 and the magnet element 12, which protrudes somewhat in relation to the door leaf 11. The release device 20 is in its pressed-in actuating position, as can readily be seen by comparing FIG. 4 and FIG. 2 and the floor seal 16 is lowered into the closing position in which it provides a seal towards the underlying surface 23.

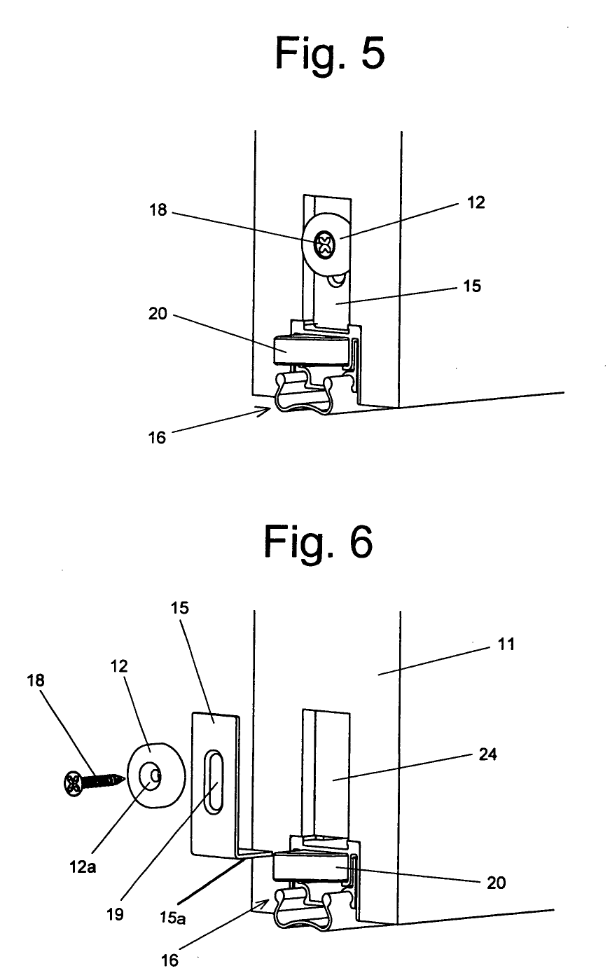

A third exemplary embodiment of the invention is described below with reference to FIGS. 5 and 6. This variant embodiment is similar to the variant previously described with reference to FIGS. 3 and 4. However, the angle bracket 15 has a slot 19, as the exploded view according to FIG. 6 shows. As a result, it is first possible to fix the magnet element 12 in different height settings via the fastening screw 18 and therefore to vary the height of magnet element 12 with respect to the angle bracket 15. As FIG. 6 shows, there is a depression 24 on the door leaf 11, so that the angle bracket 15 can be fixed on the door leaf 11 in a somewhat embedded position. The floor seal 16 can be fixed to a lower horizontal limb 15a of the angle bracket.

The slot 19 present on the angle bracket 15 also provides the possibility of, for example, installing the floor seal 16 in a somewhat inclined (sloping) position with respect to the horizontal and the door leaf 11 if, for example, the lower door gap differs in width over the length of the sliding door. It may also be expedient to produce a sloping plane via the angle bracket 15 if, for example, the door leaf is installed in a somewhat sloping manner, i.e. the end side of the door leaf 11 does not run exactly parallel to the frame of the sliding door. Also in the case of this variant, the magnet element 12 is of the disc-shaped configuration with an approximately central hole 12a, so that the fastening screw 18 can be screwed through this hole 12a and the slot 19 into the region of the depression 24 of the door leaf 11.

This application claims the priority, under 35 U. S.C. §119, of German application DE 20 2005 011 984.9, filed Jul. 30, 2005; the prior application is herewith incorporated by reference in its entirety.

We claim:

1. A sealing configuration for a sliding door having a door leaf, comprising:
a floor seal;
a mechanism for lowering said floor seal, said mechanism having a defined spring force and a release device protruding from an end side of the door leaf and, during a closure of the sliding door, said release device being pressed counter to the defined spring force acting upon said release device; and
a closing mechanism for opposing an opening tendency of the sliding door occurring due to said defined spring force acting on said release device, said closing mechanism containing at least one magnet element for drawing the door leaf in a closing direction.

2. The sealing configuration for the sliding door according to claim 1, wherein said closing mechanism further contains a magnet counterpart for said at least one magnet, said at least one magnet element and said magnet counterpart each being fixed on one of the end side of the door leaf or on a door frame.

3. The sealing configuration for the sliding door according to claim 1, wherein said at least one magnet element is at least partially embedded in a groove of the door leaf or of a door frame.

4. The sealing configuration for the sliding door according to claim 3, further comprising a spring element, said magnet element being mounted in an axially resilient manner via said spring element in said groove of the door leaf or the door frame.

5. The sealing configuration for the sliding door according to claim 2, wherein one of said magnet element and said magnet counterpart is fixed in a lower region on the end side of the door leaf.

6. The sealing configuration for the sliding door according to claim 2, further comprising a fastening element fastening one of said magnet element and said magnet counterpart on the end side of the door leaf.

7. The sealing configuration for the sliding door according to claim 2, further comprising a fastening element fixing one of said magnet element and said magnet counterpart, said fastening element further fastening said floor seal to the door leaf.

8. The sealing configuration for the sliding door according to claim 1, wherein said magnet element is disc-shaped.

9. The sealing configuration for the sliding door according to claim 1,
wherein said magnet element has a centrally disposed perforation formed therein; and
further comprising a fastening screw fastening said magnet element through said perforation on the end side of the door leaf.

10. The sealing configuration for the sliding door according to claim 1, further comprising an angle bracket having a slot formed therein, said magnet element being fixed on said angle bracket, said angle bracket being fastened to the door leaf in an angular position with respect thereto.

11. The sealing configuration for the sliding door according to claim 1, wherein said magnet element has a size and/or and a material forming said magnet element being selected such that a tendency of the sliding door to open, which is provided by said release device acted upon with said defined spring force, is overcompensated for only to a certain extent.

12. The sealing configuration for the sliding door according to claim 2, wherein a magnetic force acting in the closing direction of the sliding door is determined via a size and/or a material thickness of said magnetic counterpart.

13. The sealing configuration for the sliding door according to claim 5, further comprising a fastening device fastening said floor seal to the sliding door, said magnet element or said magnet counterpart being fixed in the lower region on the end side of the door leaf above said fastening device.

14. The sealing configuration for the sliding door according to claim 6, wherein said fastening element is selected from the group consisting of screws and adhesives.

15. The sealing configuration for the sliding door according to claim 7, wherein said fastening element is an angle bracket.

16. The sealing configuration for the sliding door according to claim 9, further comprising an angle bracket which together with said fastening screw fastening said magnet element through said perforation on the end side of the door leaf.
